(19) United States
(12) Patent Application Publication
(10) Pub. No.: US 2006/0175132 A1
(43) Pub. Date: Aug. 10, 2006

(54) Personal descent apparatus

(76) Inventors: Jung-Myung Chun, Tongyong-City (KR); Myoung-Oh Kim, Pusan (KR); Jae-Ryoong Chun, Tongyong-City (KR)

Correspondence Address: IPLA P.A., 3580 WILSHIRE BLVD., 17TH FLOOR, LOS ANGELES, CA, 90010, US

(21) Appl. No.: 10/564,878

(22) PCT Filed: Jul. 19, 2004
(86) PCT No.: PCT/KR04/01785

§ 371 Date: Jan. 17, 2006

(30) Foreign Application Priority Data
Jul. 25, 2003 (KR) 10-2003-0051573

(51) Int. Cl. A62B 1/20

(52) U.S. Cl. 182/192

(57) ABSTRACT

A personal descent apparatus for evacuating occupants from a high elevation of tall building under emergency. The personal descent apparatus comprises a pair of supporting plates connected to each other front and rear with a predetermined gap, braking rods rotatably fixed to the pair of supporting plates in the predetermined gap between the pair of supporting plates, the braking rods form a passage which is formed by two guide grooves each of which is tapered and formed at arc ends facing to each other, so that a rope is inserted to the passage, and weight receiving means connected to both ends of the braking rods for receiving a load, wherein the braking rods are rotated by the load.

### TECHNICAL FIELD

The present invention relates to a descent apparatus for safely descending from a high elevation of a tall building to the ground using a rope, and more particularly, to a personal descent apparatus which is compact and portable. Also the personal descent apparatus includes tapered guide grooves at each arc end of braking rods. It obtains braking force by that, when a predetermined load is applied to weight receiving means connected to the braking rods, the braking rod is rotated with respect to a pivot pin by the lever principle, and then a passage formed between the guide grooves becomes narrower such that a rope in the passage is pressed by the guide grooves, whereby the descending speed of occupant tied by a belt connected to the weight receiving means is decreased or zero.

### BACKGROUND ART

Generally, a descent apparatus or descending pulley for emergency evacuation is installed at a tall buildings such as apartment, hotel and motel etc. and used by occupants who cannot evacuate from the emergency building through an elevator or stairs.

The prior art reel typed descent apparatus is large and expensive. Also its operation method is very complicate such that unskilled person cannot easily operate it under emergency. Meanwhile, most of the prior art large descent apparatuses are fixed to a predetermined place of a building, therefore they can be easily destroyed by fires. Also, since a braking force of a large descent apparatus is determined by only a viscous fluid, a braking force reliability thereof is relatively low.

Korean utility model publication No. 10-1994-0011939, filed on Jun. 15, 1994, entitled descending pulley for emergency evacuation, Korean utility model registration No. 0217780, filed on Jan. 11, 2001, entitled descending pulley, and Korean utility model registration No. 0297766, filed on Nov. 29, 2002, entitled portable descent apparatus disclose the solutions to resolve the prior art problems. But, they have still some problems that a durability is low and a braking force reliability is low.

Also, most of the prior art descent apparatuses are fixedly installed at a pre-determined place in a building and designed to use for only a single type device. When operating, next occupant cannot evacuate until one occupant evacuates from the high elevation to the ground. Also, after the apparatus used by a first occupant must be returned to other occupants in an emergency building. Therefore, the prior art descent apparatus cannot successively evacuate the occupants to the ground from a high elevation of a tall building. Therefore, occupant using the prior art descent apparatus takes much time to evacuate. Especially, the prior art descent apparatus has dis-advantages in that its descending velocity cannot be controlled by a currently evacuating occupant on the rope while he/she evacuates.

### DISCLOSURE OF INVENTION

Technical Problem

Accordingly, to resolve the problems of the prior art descent apparatus mentioned above, it is an object of the present invention to provide a personal descent apparatus, structurally, which is compact, portable, and formed guide grooves at each arc end of braking rods to sufficiently provide durability and braking force reliability, and, operatingly, which obtains braking force by that, when a predetermined load is applied to weight receiving means connected to the braking rods, the braking rod is rotated with respect to a pivot pin by the lever principal, and then a passage formed between guide grooves becomes narrower such that a rope in the passage is pressed by the guide grooves, whereby the descending speed is decreased or zero.

It is another object of the present invention to provide a personal descent apparatus, capable of controlling its descending speed by braking force controlling means which controls grasping power applied to a rope in the passage formed at ends of the controlling rods, and thusly supplementing main controlling main braking force generated by the braking rods.

It is a yet object of the present invention to provide a structure for fast and easily installing a personal descent apparatus into a rope under emergency such as a fire etc.

It is a still further object of the present invention to provide means for securing a durability thereof.

It is a yet still further object of the present invention to provide a personal descent apparatus for successively evacuating occupants through a single rope installed at a predetermined place such that other occupants can evacuate while a first occupant currently evacuates.

Technical Solution

In order to achieve the above object, there is provided to a personal descent apparatus for evacuating occupants from a high elevation of tall building under emergency comprising a pair of supporting plates, the supporting plates being connected to each other front and rear with a predetermined gap, braking reds rotatably fixed to the pair of supporting plates in the predetermined gap between the pair of supporting plates, the braking rods forming a passage which is formed by two guide grooves each of which is tapered and formed at arc ends facing to each other, so that a rope is inserted to the passage, and weight receiving means connected to both ends of the braking rods for receiving a load, wherein the braking rods are rotated by the load

Advantageous Effects

The personal descent apparatus according to the present invention can obtain braking force as a rope is grasped by that a passage of the braking rods becomes gradually narrower. Also the personal descent apparatus can grantee a relatively large durability and a relatively large braking reliability. Also, the personal descent apparatus is structurally compact and portable.

The personal descent apparatus of the present invention can easily control braking force applying to the rope by braking force control means, wherein the braking force control means further installed to the apparatus supplements main braking force. Therefore the occupant can relatively easily control his/her descending speed by him/her-self.

Using a supporting plate structure of separating members, hinge connected to the separating members and locking means, the personal descent apparatus can be easily and fast installed to the rope under emergency. Also the personal descent apparatus can secure a relatively high durability of the separating members.

The prior art descent apparatus has disadvantages in that it evacuates the occupants one by one. Namely, when a current occupant evacuates through a rope using the prior art descent apparatus, next occupant cannot use the rope until the current occupant completely goes down to the ground. Also the prior art descent apparatus used by the current occupant must be returned to the remaining occupants at the emergency place. However, the personal descent apparatus of the present invention is structurally compact and portable, and its descending speed can be arbitrarily controlled by an occupant while he/she evacuates, therefore a plurality of occupants can successively evacuate through a single rope. Namely while the current occupant goes down the ground, next occupants can also use the same rope for his/her evacuation.

For example, in the case that an evacuation is performed from the fifth floor, the prior art descent apparatus evacuates one occupant, but the personal descent apparatus of the present invention does about ten occupants. Also in the case that an evacuation is performed from the tenth floor, the prior art descent apparatus evacuates one occupant, but the personal descent apparatus of the present invention does about thirty occupants.

The personal descent apparatus of the present invention is relatively small such that the user can easily carry it and thusly evacuate through other rope available at the same building.

The prior art descent apparatus has been installed to every predetermined place only one by one, but the personal descent apparatus of the present invention can be used if only the rope is installed to the building. Namely, even if the rope was not installed to a place, if only the rope is currently installed at a place, the occupants can evacuate through the rope, since the descent apparatus can be easily connected to the rope.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

In the drawings:

FIG. 1 and FIG. 2 are exploded perspective views of the personal descent apparatus according to the present invention;

FIG. 3 is a partially exploded cross-sectional view of the personal descent apparatus according to the present invention;

FIG. 4 is a rear view of the personal descent apparatus according to the present invention;

FIG. 5 is a top view of the personal descent apparatus according to the present invention;

FIGS. 6 and 7 are cross-sectional views for explaining the operation states that a rope is inserted into a passage formed between the guide grooves of braking rods;

FIGS. 8 and 9 are schematic views for explaining the operation states of the personal descent apparatus; and

FIGS. 10 and 11 are cross-sectional views for explaining the operation states according to another embodiment of the present invention.

### BEST MODE FOR CARRYING OUT THE INVENTION

The principles and operation of a personal descent apparatus according to the present may be better understood with reference to the drawings and accompanying descriptions.

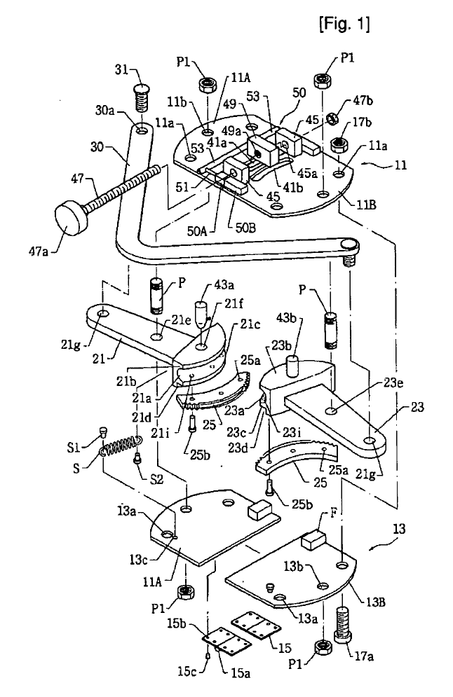

First of all, we will define the directions in the drawings and descriptions for better understanding of the present invention. Basically, the directions are defined based on a coordinate system, as shown in FIG. 1. More specifically, “front” or “front side” indicates a side where braking force control means 50 arranged to supporting plate 11 is positioned, and “rear” or “rear side” is opposite of “front” or “the front side”. “Internal” or “internal side” indicates a side where a gap of two rotating pins P for braking rods 21 and 23, and “external” or “external side” is opposite of “internal” or “the internal side”. “Lower” or “lower side” indicates a side where weight receiving means 30 receiving occupant's weight is positioned, and “upper” or “upper side” is opposite of “lower” or “the lower side.”

In addition, the same reference numeral indicates the same member in the drawings and descriptions.

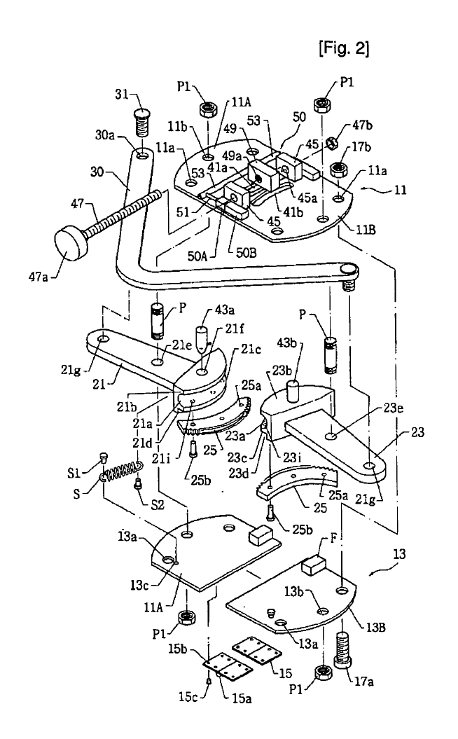

FIG. 1 and FIG. 2 are exploded perspective views of the personal descent apparatus according to the present invention.

As shown in the drawings, the personal descent apparatus includes a pair of upper and lower supporting plates 11 and 13, two braking rods 21 and 23 fixed to between the pair of upper and lower supporting plates 11 and 13 by a rotating pin P, and weight receiving means 30 connected to the two braking rods 21 and 23. When receiving load, the weight receiving means 30 rotates the braking rods 21 and 23 to the pin P based on the lever principle, and then presses a rope suspended from a high elevation of the emergency building to the ground. Therefore, the descending speed can be reduced or zero as it halts on a rope.

Referring to FIGS. 1 and 2, the upper and lower supporting plates 11 and 13 are connected to each other by connecting means inserted to connecting holes 11a and 13a. The connecting means is preferably a bolt 17a and a nut 17b.

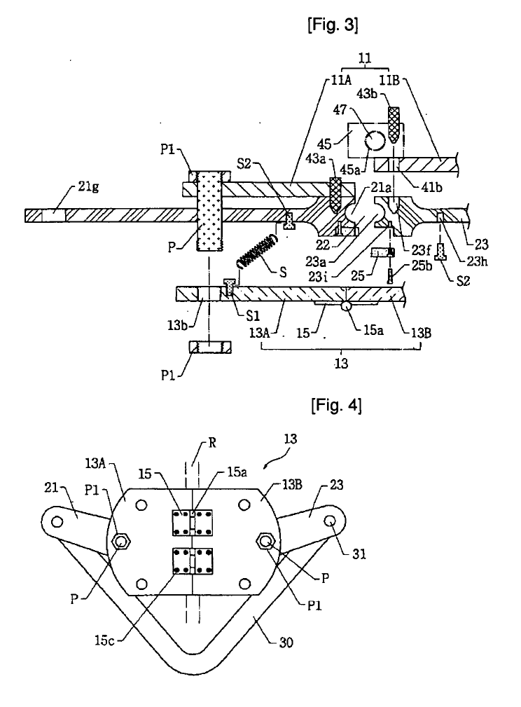

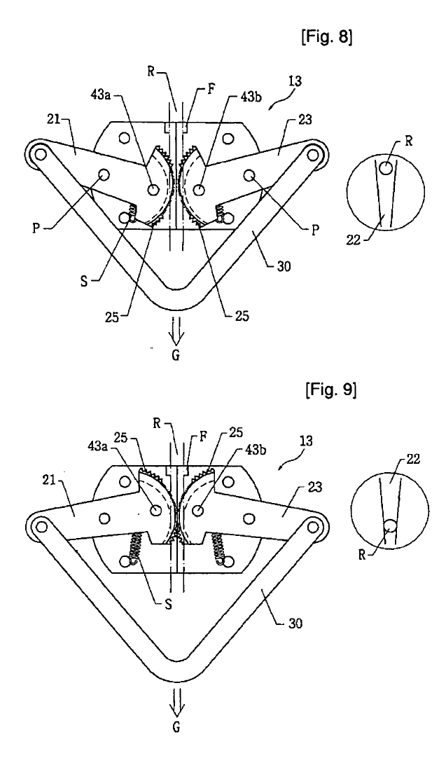

Referring to FIGS. 1 and 3, each end of the internal sides of the two braking rods 21 and 23 is shaped as an arc. The ends face to each other. The arc ends form guide grooves 21a and 23a which are tapered for the rope. There is a passage 22 formed between the guide grooves 21a and 23a. The braking rods 21 and 23 are fixed to between the front side and the rear side supporting plates 11 and 13 as the rotating pin P is inserted into the connecting holes 21e, 23e, 11b and 13b formed in the rods 21 and 23 and the front side and rear side supporting plates 11 and 13, respectively, and then both ends of the pin P are connected by a nut P1. As the braking rods 21 and 23 are rotated to the pin P, the arc ends thereof are surfacially and rotatably contacted. The passage 22 is tapered (refer to a circle shown in FIG. 8).

Referring to FIGS. 1 and 2, the weight receiving means 30 is connected to external ends of the two braking rods 21 and 23 by connecting means such as a bolt 31. The weight receiving means 30 is further connected to a belt for occupant, which is not shown in the drawings. When occupant's weight is transferred to the weight receiving means 30, the external ends of the braking rods 21 and 23 receive the weight and the braking rods 21 and 23 are rotated to the rotating pin P such that the internal arc ends rose to the upper side. Then cross-sectional area of the passage 22 is decreased. Namely, as an effective area of the passage 22 becomes narrower, the braking rods 21 and 23 press the rope. Therefore, the descending speed of the personal descent apparatus installed to the rope can be reduced or zero. The weight receiving means 30 is preferably made of soluble material such as synthetic resin, so that its form is easily transformed, according as the braking rods 21 and 23 are rotated when receiving load.

Referring to FIGS. 2 and 3, internal arc ends of the braking rods 21 and 23 may have gears to operate together with the braking rods 21 and 23. Even though the gears may be integratedly embodied with front protrusions 21b and 21c and rear protrusions 23b and 23c, they are implemented as separating gear members for simple manufacture. Therefore, after being separately manufactured, they are assembled to the braking rods 21 and 23, as shown in FIGS. 1 and 2. Namely, the gear member 25 is assembled to the braking rods 21 and 23 like that it is putted on rear grooves 21d and 23d adjacent to the lower protrusions 21c and 23c of the internal end of the braking rods 21 and 23, and fixed thereto as bolts 25b are inserted into connecting holes 25a, 21i and 23i. Each of the connecting holes 25a, 21i and 23i is formed on the gear member 25 and the braking rods 21 and 23.

Meanwhile, the gear member 25 is individually included on the rear side of the braking rods 21 and 23, which is related to a structure of separating body of supporting plates 11 and 13 for rapidly positioning the rope to the passage 22 under emergency, which will be explained in detail later.

Referring to FIGS. 1 and 8, since the braking rod 21 and 23 and the supporting plate, preferably the rear supporting plate 13, are connected to each other by an elastic member S, when load does not apply to the braking rods 21 and 23, the cross-sectional area of the passage 22 forms relatively large, therefore the braking rod is positioned therein. Referring to FIGS. 2 and 3, the elastic member S is fixed to the supporting plates and the braking rods by connecting means S2 inserted to a ring of the elastic member S and connecting holes 13c, 21i and 23i of the rear supporting plate 13 and the braking rods 21 and 23, respectively.

Referring to FIGS. 2 to 4, each of the supporting plates 11 and 13 includes two separating bodies (11A and 11B) and (13A and 13B), respectively, so that a rope can be easily inserted into the passage 22 by the supporting plates 11 and 13 under emergency. The rear separating bodies 13A and 13B of the rear supporting plate 13 are connected to each other by a hinge 15 and connecting means, such as preferably a bolt 15C, inserted to connecting hole 15b.

Referring to FIGS. 2 to 5, locking means 50 for the front supporting plate 11 is explained in detail below:

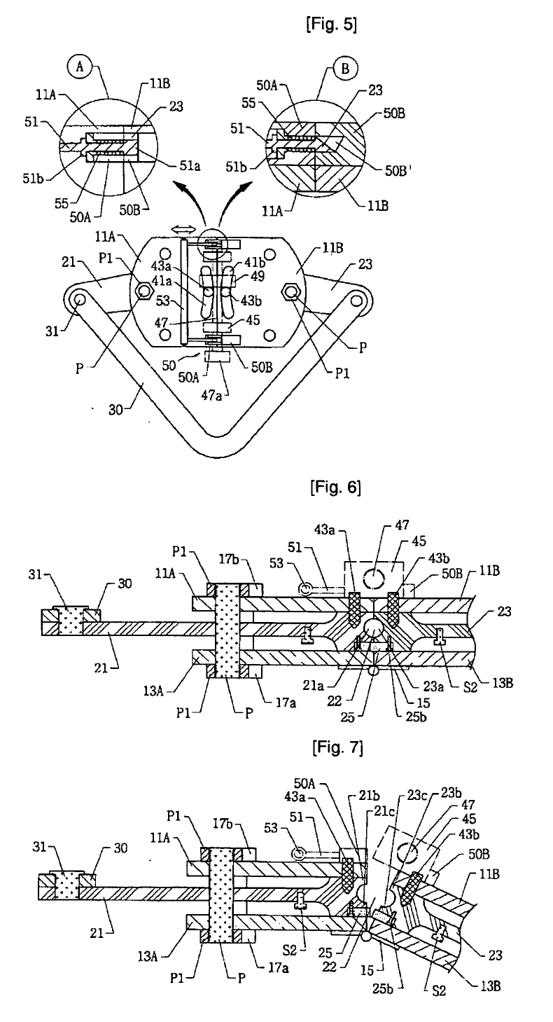

FIG. 5 is a top view of the descent apparatus according to the present invention, especially the circles are cross-sectional views illustrating major part of the locking means with different viewing angles.

Circle A is an enlarged view illustrating the cross-section cut from the upper side to the lower side with respect to the front side. Circle B is an enlarged view illustrating the cross-section cut from the front side to the rear side with respect to the rear side. In each drawing, the front separating bodies 11A and 11B of the front supporting plate 11 are locked and unlocked by the locking means 50. The locking means 50 includes fixing members 50A and 50B fixed to the separating members 11A and 11B, elastic means 55 installed within an internal space of the fixing member 50A, and flipping rod 51 flipped by the elastic means S. Here, the locking means 50 is in a locking state if one end 51a of the flipping rod 51 is inserted into a groove 50B′ of the fixing member 50B and in unlock state if the end 51a of the a of the flipping rod 51 is taken out from the groove 50B′ as a handle 53 connecting the flipping rod 51 thereto is pulled. The flipping rod 51 is limited its variable position by the end 51a and escaping checker 51b.

Even though the embodiments of the present invention above are mentioned based on the drawings, we can easily appreciate that the present invention cannot be limited by the embodiments but instead there are various modifications and changes therefrom by modifying or chaning position and number of the fixing members 50A and 50B of the locking means 50, position and number of the flipping rod 51, whether the handle 53 is, whether the fixing member 50B is, form of the end 51a of the flipping rod 51, and whether the escaping checker 51b is.

Referring to FIGS. 6 and 7, if the locking means 50 is in unlock state as the handle 53 is pulled and the supporting plates 11 and 13 are bent back (the rear side), the rear separating members 13A and 13B of the rear supporting plate 13 are rotated to hinge pin 15a of hinge 15 and then the front separating members 11A and 11B of the front supporting plate 11 are separated from each other.

Meanwhile, if the supporting plates are not manufactured as a separating type, the descending apparatus requires open end of the rope. Namely, to install to the rope, the occupant must lift up open end of the rope, which is suspended on the ground at his/her position of the high elevation of the tall building, so that the descending apparatus is installed into the rope, or the occupant must release the fixed end of the rope which is fixed at his/her position of the high elevation of the tall building. Therefore, if the supporting plates 11 and 13 are not separately manufactured, they cannot easily intalled.

Since the supporting plates 11 and 13 of the present invention can be cooperatively operable, as shown in FIGS. 6 and 7, they can make the personal descent apparatus easily install to a rope body.

As mentioned above briefly, when the rope is installed to the passage 22 toward the rear side from the front side, the rope cannot be blocked by that the gear member is formed only on the rear protrusions 21c and 23c of the braking rods 21 and 23 rather than on both of the front protrusions 21b and 21c and the rear protrusions 23b and 23c. The rope inserted into the passage 22 is easily positioned at the mile of the supporting plate by a position fixing means F formed on the rear supporting plate 13. The position fixing means F can halt the personal descent apparatus on the rope while the personal descent apparatus goes down from the high elevation to the ground.

Since the braking rods 21 and 23 are positioned by the elastic means S connecting the braking rods 21 and 23 to the rear supporting plate 13 at a portion where the cross-sectional area of the passage 22 is largest, inserting the rope to the passage 22 can be easily achieved. Also, after the rope is inserted by the elastic means S, if the supporting plates 11 and 13 become a normal state to show an even external appearance again, and if the locking means 50 is in the locking state, the braking rods 21 and 23 are symmetrically in a staying state. In operation, the braking rods 21 and 23 are symmetrically rotating.

Meanwhile, the personal descent apparatus may further include braking force control means 40 for controlling descending speed thereof arbitrarily, so that it helps the braking rods 21 and 23 which mainly produce the braking force and supplements the braking force.

Referring to FIGS. 1, 2 and 5, each of the braking force control means 40 is protrudently formed in internal side of each rotating pin P of the two supporting plates 11 and 13. The braking force control means 40 includes protrusions 43a and 43b exposed to the guide holes 41a and 41b formed on the front supporting plate 11; bracket 45 fixed to the front supporting plate 11 forming guiding holes 41 and 41b; screw control rod 47 inserted into a hole 45a of the bracket 45 and a pressing plate 49 inserted in the screw control rod 47 for pressing the protrusions 43a and 43b while moving upper and lower sides according to the rotation of the screw control rod 47 and for rotating the braking rods 21 and 23.

Especially, the bracket 45 is included at both ends of the screw control rod 47 for its stable movement. The screw control rod 47 is connected to bolt 47b at the opposite end of the handle 47a and performs stall state between two brackets 45. Also, since the rotation of the pressing plate 49 is restricted by the supporting plate 11, if the handle 47a of the control rod 47 is rotated, the pressing plate 49 linearly moves as the female screws formed in the hole 49a of the pressing plate 49 go in gear with male screws formed on the outer surface of the control rod 47.

In FIG. 5, the pressing plate 49 is positioned on the upper side of the protrusions 43a and 43b.

Therefore, if the pressing plate 49 moves up and lower sides according to the rotation direction of the control rod 47, the protrusions 43a and 43b are also moved up and lower sides. Therefore, it can increase or decrease the grasping power to applying to the rope positioned in the passage 22 of the braking rods 21 and 23.

If the weight receiving means 30 receives a load, as shown in FIGS. 8 and 9, the braking rods 21 and 23 are rotated upper. Then the passage 22 is gradually narrower such that it presses the rope. Therefore, the grasping power applying to the rope by the load of the weight receiving means is gradually increased, therefore the personal descent apparatus reduces its descending speed or halts.

Meanwhile, if the pressing plate 49 is moved at the lower side by the rotation of the control rod 47, the protrusions 43a and 43b are also moved to the lower side. Then the braking rods 21 and 23 are also rotated to the lower side such that it reduces the grasping power applying to the rope. Therefore, the personal descent apparatus starts to descend from a halt state.

Here, since the grasping power applying to the rope from the braking rods 21 and 23 can be controlled by the rotation amount of the control rod 47, the descending speed can be also controlled.

Also, the guide grooves 21ad and 23a of the braking rods 21 and 23 may further form convex or concave members for increasing braking force.

FIGS. 8 and 9 are schematic views illustrating states that the rope R is pressed by the descent apparatus of the present invention, and that the upper supporting plate 11 is removed therefrom. Namely, the state of FIG. 8 is changed from the state of FIG. 7 as the locking means 50 is unlocked, the supporting plates 11 and 13 are bent and then the rope is inserted into the passage 22 of the braking rods 21 and 23.

Circle of FIG. 8 shows a schematic view of a trajectory of the passage 22, which is formed by guide grooves 21a and 23a according as the braking rods 21 and 23 are rotated to the rotation pin P. In case of the state that load does not apply to the weight receiving means 30, the rope R is positioned at a portion where the cross-sectional area of the passage 22 is the most large.

As shown in FIG. 9, when the occupant whose body is tied in a belt connected to the weight receiving means 30 goes down the ground under emergency, the braking rods 21 and 23 are rotated to the rotation pin P due to the occupant's weight such that the internal arc ends of the braking rods 21 and 23 are raised. Therefore, while the passage 22 becomes narrower, the rope R is pressed, as shown the circle of FIG. 9 and the descending speed of the occupant is reduced or halted.

Mode for the Invention

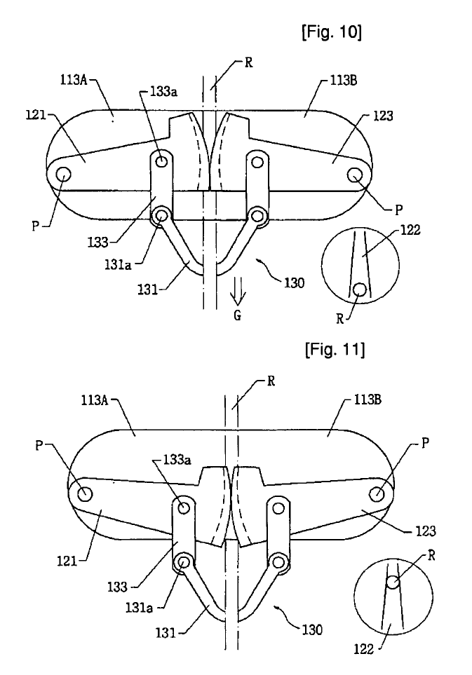

FIGS. 10 and 11 are cross-sectional views for explaining an operation state according to another embodiment of the present invention, in which the front supporting plate is not shown.

As shown in FIG. 1, the connecting position of the weigh receiving means 30 connected to the braking rods 21 and 23 is at the external side of the rotation pin P. Meanwhile, the weigh receiving means 130 of FIG. 10 is connected to the internal side of the rotation pin P.

Regarding the shape of passage, the passage 22, as shown in FIG. 1, is shaped as its upper side is wide and its lower side is narrow. Meanwhile, the passage 122 of FIG. 8 is shaped as its upper side is narrow and its lower side is wide.

The weight receiving means 30 of FIG. 1 is made of soluble material, forming an integrated body. Meanwhile, the weight receiving means 130 of FIG. 10 is made of hard material, forming two members 131 and 133 so that it changes its shape according to the rotation of the braking rods 121 and 123. The two members 131 and 133 are connected to each other by a connecting means, preferably rivet 131a. Also the member 133 is connected to the braking rods 121 and 123 by a rivet 133a.

Considering the lever principle, to obtain more large braking force, only the braking rods 21 and 23 of FIG. 1 are elongated to the external side of the rotation pin P. However, the braking rods 121 and 123 are enlarged to the internal side and the supporting plates are also enlarged, in another embodiment in FIG. 10.

The operation of the descent apparatus from FIG. 10 to FIG. 11 is performed like that, when the weight receiving means 130 receives load, the end of the braking rods 121 and 123 connect thereto moves to the lower side and then the passage 122 becomes narrower such that the rope is pressed. Therefore the descending speed can be reduced or halted.

There may be another modification from the embodiments, which is achieved as the braking rods 21 and 23 are protruded from the supporting plates 11 and 13, while only the pressing plate 49 is positioned at the lower side of the protrusions 43a and 43b.

### INDUSTRIAL APPLICABILITY

As so far described, even though the embodiments of the descent apparatus according to the present invention are mainly explained for an evacuation from emergency building, it is reasonable to foresee alternative embodiments for other applications such as an external wall work of tall buildings, rescue system cliff search, and leisure equipment such as fishing, climbing, etc.

It will be appreciated by persons skilled in the art that there may be many modifications, variations and combinations from the characteristics of the present invention based on the drawings attached, but if the Edifications, variations and combinations are related to a tapered guide groove of the arc end of the braking rod operated by the lever principle, and to a roped to which a grasping power applied as a passage vary its cross-section area formed between the guide grooves according to the rotation of the braking rods, the modifications, variations and combinations must be analyzed to be include in the scope of the present invention.

1. A personal descent apparatus for evacuating occupants from a high elevation of tall building under emergency comprising:
a pair of supporting plates, the supporting plates being connected to each other front and rear with a predetermined gap;
braking rods rotatably fixed to the pair of supporting plates in the predetermined gap between the pair of supporting plates, the braking rods forming a passage which is formed by two guide grooves each of which is tapered and formed at arc ends facing to each other, so that a rope is inserted to the passage; and
weight receiving means connected to both ends of the braking rods for receiving a load, wherein the braking rods are rotated by the load.

2. The personal descent apparatus according to claim 1, wherein said passage formed between the guide grooves of the braking rods is shaped as its cross-sectional area is gradually increased from upper to lower, and said weight receiving means is connected to internal side of rotation center of the braking rods.

3. The personal descent apparatus according to claim 1, wherein the passage formed between the guide grooves of the braking rods is shaped as its cross-sectional area is gradually decreased from upper to lower, and said weight receiving means is connected to external side of rotation center of the braking rods.

4. The personal descent apparatus according to any one of claims 1 to 3, further comprising braking force control means, wherein the braking force control means includes:
protrusion exposed to guide hole formed in one of the supporting plates, the protrusion being protrudently formed on the internal side of each rotation pin of the braking rods;
bracket fixed to the supporting plates on which the guide holes are formed;
screw control rod inserted to hole of the bracket; and
pressing plates inserted to the screw control rod for rotating the braking rods, as the pressing plates move upper and lower according to rotation of the screw control rod and press the protrusions.

5. The personal descent apparatus according to any one of claims 1 to 3, wherein each of said supporting plates comprises two separating members, wherein said two separating members included in one supporting plate are rotatably connected to each other by hinge, and one separating member of the two separating members included in another supporting plate includes locking means, wherein the locking means includes flipping rod checking front and rear movement of other separating member flipped by elastic means installed within a fixing means.

6. The personal descent apparatus according to any one of claims 1 to 3, wherein each of said protrusion toward the guide groove of the braking rods forms gear thereon, such that the braking rods are geared when the gears of the braking rods go in gear and rotate.

7. The personal descent apparatus according to any one of claims 1 to 3, wherein said weight receiving means is male of soluble material.

8. The personal descent apparatus according to any one of claims 1 to 3, wherein, in a state that said weight receiving means does not receive load, the braking rods are positioned at a position where cross-sectional area of the passage between the guide grooves is largest by elastic member connecting each of the braking rods with the supporting plate.
